(19) United States
(12) Patent Application Publication
(10) Pub. No.: US 2022/0398690 A1
(43) Pub. Date: Dec. 15, 2022

(54) REMOTE ASSISTANCE SYSTEM AND REMOTE ASSISTANCE METHOD

(71) Applicant: WOVEN PLANET HOLDINGS, INC., Tokyo (JP)

(72) Inventors: Sho MIKURIYA, Yokohama-shi (JP); Ryo IGARASHI, Tokyo-to (JP); Daisuke ISO, Tokyo-to (JP)

(73) Assignee: WOVEN PLANET HOLDINGS, INC., Tokyo (JP)

(21) Appl. No.: 17/834,477

(22) Filed: Jun. 7, 2022

(30) Foreign Application Priority Data
Jun. 10, 2021 (JP) 2021-097501

(51) Int. Cl. G06T 3/40; G06V 20/58; G06T 5/00; G06T 7/246; G06V 10/22; G06T 11/00; G08G 1/01; G08G 1/04

(52) U.S. Cl. CPC G06T 3/4053; G06V 20/58; G06T 5/006; G06T 7/246; G06V 10/225; G06T 11/00; G08G 1/0112; G08G 1/04; G06T 2207/30252

(57) ABSTRACT

A processor of a remote facility executes image generation processing and display control processing. In the image generation processing, it is determined whether a front image includes an image of a mirror portion of a traffic mirror based on data of feature quantity of an object included in the front image. If it is determined that the front image includes the mirror portion image, an image of a preset region including the mirror portion is extracted from the front image. Then, a super-resolution image is generated by super-resolution processing for the image of this preset region. In the display control processing, if the front image includes the image of the mirror portion, the super-resolution image and the front image is displayed on a display of a remote facility.

The present application claims priority under 35 U.S.C. § 119 to Japanese Patent Application No. 2021-097501, filed Jun. 10, 2021, the contents of which application are incorporated herein by reference in their entirety.

### TECHNICAL FIELD

The present disclosure relates to a system and a method for a remote assistance of running of a vehicle.

### BACKGROUND

JP2018-106667A discloses a system in which information to assist an operation of a vehicle by a driver is generated. The conventional system detects a traffic mirror in front of the vehicle based on image data acquired by a camera disposed on the vehicle. The traffic mirror is a convex mirror installed at an intersection with poor visibility, in a middle of a curve that is hard to see ahead, or the like.

If the traffic mirror is detected, the conventional system recognizes a moving body in this traffic mirror. The recognition of the moving body is performed using a mechanical learning such as a deep learning. If the moving body is recognized, the conventional system calculates a size of the moving body in the traffic mirror. The information to assist the operation of the vehicle is generated based on increasing or decreasing speed of the size. For example, if the increasing speed exceeds a threshold, the information to control a braking device is generated.

Consider a case where the operation of the vehicle is remotely assisted. The remote assistance is performed by an operator residing in a management facility. The operator performs the remote assistance while watching a display of the management facility. Image data acquired by a camera disposed in the vehicle is outputted to the display. Therefore, it is desirable that a sharp image data be output to the display. In particular, when the traffic mirror is included in the image data, it is desirable that a clear image data of a mirror portion of the traffic mirror is outputted even when a distance from the vehicle to the traffic mirror is long.

However, because of a limitation in a communication traffic from the vehicle, it is expected that a resolution of the image data received by the management facility will not be very high. Therefore, even if the management facility receives low resolution image data, it is necessary to develop a technique to improve the information displayed in the mirror portion included in this image data to a level at which the operator can recognize.

It is an object of the present disclosure to provide a technique capable of improving the mirror portion of the traffic mirror included in the image data transmitted from the vehicle to a level at which the operator performing the remote assistance of the vehicle can recognize.

### SUMMARY

A first aspect is a remote assistance system and has the following features.

The remote assistance system comprises a vehicle and a remote facility to assist an operation of the vehicle.

The remote facility includes a memory and a processor. The memory stores data of a front image representing an image in front of the vehicle and data of a feature quantity of an object included in the front image. The processor is configured to execute image generation processing to generate assistance image data to be output to a display of the remote facility based on the front image data and the feature quantity data, and display control processing to output assistance image data to the display.

In the image generation processing, the processor is configured to:

based on the feature quantity data, determine whether the front image includes an image of a mirror portion of a traffic mirror;

If it is determined that the front image includes the image of the mirror portion, extract an image of a preset region including the mirror portion from the front image; and

execute super-resolution processing on the image of the preset region to generate a super-resolution image.

In the display control processing, the processor is configured to:

if the front image does not include the image of the mirror portion, output the front image data to the display as the assistance image data,

if the front image includes the image of the mirror portion, output the super-resolution image data and the front image data to the display as the assistance image data.

A second aspect further has the following feature in the first aspect.

In the display control processing, the processor is configured to:

if the front image includes the image of the mirror portion, output the super-resolution image data to a region of the display while outputting the front image data a remaining region of the display.

A third aspect further has the following feature in the first aspect.

The feature quantity includes a slope angle of the mirror portion to a base surface.

In the image generation processing, the processor is configured to;

if it is determined that the front image includes the image of the mirror portion, before executing the super-resolution processing on the image of the preset region, execute a distortion correction of the image of the preset region based on the slope angle and a curvature radius of the mirror portion to generate a corrected image of the preset region including orthoscopic image of the mirror portion;

execute the super-resolution processing to the corrected image to generate a super-resolution corrected image;

detect a moving object in the orthoscopic image based on the super-resolution corrected image; and

if no moving object is detected in the orthoscopic image, execute the super-resolution processing on the image of the preset region to generate the super-resolution image data,

if a moving object is detected in the orthoscopic image, executed the super-resolution processing on the image of the preset region image to generate the super-resolution image data and add a highlighted frame surrounding the detected moving object to the generated super-resolution image.

A fourth aspect further has the following feature in the first aspect.

The remote facility further comprises a database in which reminder icon data set according to a type of a moving object is stored.

The feature quantity includes a slope angle of the mirror portion to a base surface.

In the image generation processing, the processor is configured to:

if it is determined that the front image includes the image of the mirror portion, before executing the super-resolution processing on the image of the preset region, execute a distortion correction of the image of the preset region based on the slope angle and a curvature radius of the mirror portion to generate a corrected image of the preset region including orthoscopic image of the mirror portion;

execute the super-resolution processing to the corrected image to generate a super-resolution corrected image;

detect a moving object in the orthoscopic image based on the super-resolution corrected image; and

if no moving object is detected in the orthoscopic image, execute the super-resolution processing on the image of the preset region to generate the super-resolution image data,

if a moving object is detected in the orthoscopic image, select reminder icon data corresponding to the detected moving object by referencing the database with the detected moving object, execute the super-resolution processing on the image of the preset region to generate the super-resolution image data, and add the selected reminder icon to the generated super-resolution image.

A fifth aspect is a remote assistance method to assist an operation of a vehicle by a remote facility, and has the following features.

The remote facility includes a memory and a processor. The memory stores data of a front image representing an image in front of the vehicle and data of a feature quantity of an object included in the front image. The processor is configured to execute image generation processing to generate assistance image data to be output to a display of the remote facility based on the front image data and the feature quantity data, and display control processing to output assistance image data to the display,

The image generation processing includes:

processing to determine whether the front image includes an image of a mirror portion of a traffic mirror based on the feature quantity data;

processing to extract an image of a preset region including the mirror portion from the front image if it is determined that the front image includes the image of the mirror portion; and

processing to execute super-resolution processing on the image of the preset region to generate a super-resolution image.

The display control processing includes:

processing to output the front image data to the display as the assistance image data if the image of the mirror portion is not included in the front image, and

processing to output the super-resolution image data and the front image data to the display as the assistance image data if the image of the mirror portion is included in the front image.

According to the first or fifth aspect, if the image of the mirror portion is included in the front image, the super-resolution image is generated from the image of the preset region including the mirror portion and outputted to the display. Therefore, even if the distance from the vehicle to the traffic mirror is long, it is possible for the operator to recognize an object in the mirror portion easily. Therefore, it makes possible to ensure a driving safety of the vehicle during the remote assistance by the operator.

According to second aspect, the super-resolution image data and the front image data is outputted on the same display. Therefore, it is possible to reduce a movement of eyes of the operator as compared with a case where respective data is displayed on two displays. Therefore, it makes possible to improve the driving safety of the vehicle during the remote assistance by the operator.

According to the third aspect, if a moving object is detected within the orthoscopic image of the mirror portion, the highlighted frame surrounding this moving object is added to the super-resolution image. Therefore, it makes possible for the operator to recognize the moving object reflected in the mirror portion easily.

According to the fourth aspect, if a moving object is detected within the orthoscopic image of the mirror portion, a reminder icon corresponding to this moving object is added to the super-resolution image. Therefore, it makes possible for the operator to recognize the moving object reflected in the mirror portion easily.

### BRIEF DESCRIPTION OF DRAWINGS

FIG. 1 is a conceptual diagram for explaining a remote assistance performed in a remote assistance system according to an embodiment;

FIG. 2 is a schematic diagram illustrating an example of assistance image data to be outputted to a display;

FIG. 3 is a schematic diagram illustrating an example of the assistance image data to be outputted to the display when a super-resolution image is generated;

FIG. 4 is an enlarged view of the super-resolution image shown in FIG. 3;

FIG. 5 is a diagram illustrating another example of the super-resolution image;

FIG. 6 is a diagram illustrating still another example of the super-resolution image;

FIG. 7 is a block diagram illustrating a configuration example of a vehicle;

FIG. 8 is a diagram illustrating a configuration example of feature quantity data;

FIG. 9 is a block diagram illustrating a configuration example of a remote facility;

FIG. 10 is a block diagram illustrating a function configuration example of a data processing device of the vehicle;

FIG. 11 is a block diagram illustrating a function configuration example of a data processing device of a remote facility;

FIG. 12 is a flowchart illustrating a processing example executed by the data processing device of the remote facility;

FIG. 13 is a flowchart illustrating a flow of super-resolution processing;

FIG. 14 is a diagram illustrating an outline of the processing of step S142 in FIG. 13; and

FIG. 15 is a flowchart illustrating another example executed by the data processing device of the remote facility.

### DESCRIPTION OF EMBODIMENT

Hereinafter, a remote assistance system and a remote assistance method according to an embodiment of the present disclosure will be described with reference to the drawings. Note that the remote assistance method according to the embodiment are realized by computer process executed in the remote assistance system according to the embodiment. In the drawings, the same or corresponding portions are denoted by the same sign, and descriptions thereof are simplified or omitted.

### 1. Outline of Embodiment

### 1-1. Remote Assistance

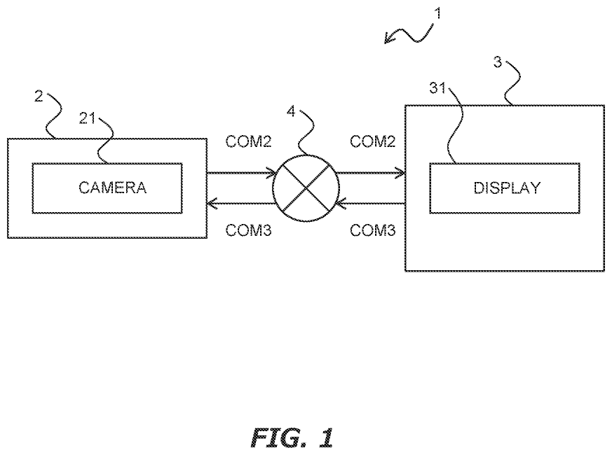

FIG. 1 is a conceptual diagram for explaining a remote assistance performed in a remote assistance system according to the embodiment. A remote assistance system 1 shown in FIG. 1 includes a vehicle 2 which is an object of the remote assistance and a remote facility 3 which communicates with the vehicle 2. A communication between the vehicle 2 and the remote facility 3 is carried out via a network 4. In this communication, communication data COM2 is transmitted from the vehicle 2 to the remote facility 3. On the other hand, communication data COM3 is transmitted from the remote facility 3 to the vehicle 2.

The vehicle 2 is, for example, a vehicle in which an internal combustion engine such as a diesel engine or a gasoline engine is used as a power source, an electronic vehicle in which an electric motor is used as a power source, or a hybrid vehicle including the internal combustion engine and the electric motor. The electric motor is driven by a battery such as a secondary cell, a hydrogen cell, a metallic fuel cell, and an alcohol fuel cell.

The vehicle 2 runs by an operation of a driver of the vehicle 2. The running of the vehicle 2 may be performed by a control system mounted on the vehicle 2. This control system, for example, assists the running of the vehicle 2 that is performed based on the operation of the driver, or performs control for an automated driving of the vehicle 2. If the driver or the control system requests to the remote facility 3 an assistance, the vehicle 2 runs based on the operations by an operator residing in the remote facility 3.

The vehicle 2 comprises a camera 21. The camera 21 captures an image (a moving image) of an environment surrounding the vehicle 2. The camera 21 includes at least one camera that is provided for capturing at least a front image of the vehicle 2 (hereinafter also referred to as a “front image IMG”). The camera 21 for capturing the front image is provided, for example, on a back of a windshield of the vehicle 2. The front image IMG acquired by the camera 21 is typically the moving image. However, the front image IMG may be a still image. Data of the front image IMG is included in the communication data COM2.

When the remote facility 3 receives an assist requiring signal from the driver of the control system of the vehicle 2, it assists the running of the vehicle 2 based on a manipulation of the operator. The remote facility 3 is provided with a display 31. Examples of the display 31 include a liquid crystal display (LCD: Liquid Crystal Display) and an organic EL (OLED: Organic Light Emitting Diode) display.

During the operation assist by the operator, the remote facility 3 generates data of the image to be output to the display 31 (hereinafter also referred to as an “assistance image AIMG”) based on data of the front image IMG received from the vehicle 2. The operator grasps the environment surrounding the vehicle 2 based on the assistance image AIMG outputted to the display 31 and inputs a support instruction to the vehicle 2. The remote facility 3 transmits data of the assistance instruction to the vehicle 2. The data of the assistance instruction is included in the communication data COM3.

Examples of the assistance by the operator include a recognition assistance and a judgment assistance. Consider a case where the control system of the vehicle 2 performs the automated naming of the vehicle 2. In this case, it may be necessary to assist the automated running. For example, when sunlight hits a traffic light in front of the vehicle 2, an accuracy of recognition in a luminescent state of a traffic light part (e.g., green, yellow or red-light part) is reduced. If the luminescent state cannot be recognized, it is also difficult to determine what action should be performed at what time. In such a case, the recognition assistance of the luminescent state and/or the determination assistance of the behavior of the vehicle 2 based on the luminescent state recognized by the operator is performed.

The assistance by the operator includes a remote operation. The remote operation is performed not only when the vehicle 2 is running automatically by the control system of the vehicle 2, but also when the vehicle 2 is running by the manipulation of the driver of the vehicle 2. In the remote operation, the operator performs an operation of the vehicle 2 including at least one of steering, acceleration, and deceleration with reference to the assistance image AIMG outputted to the display 31. In this case, the data of the assistance instruction by the operator indicates a content of the operation of the vehicle 2. The vehicle 2 executes at least one of steering, acceleration, and deceleration in accordance with the data of the assistance instruction.

### 1-2. Feature of Embodiment

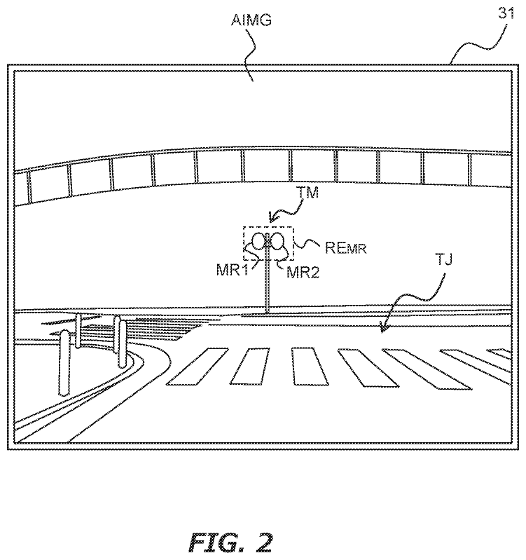

FIG. 2 is a schematic diagram illustrating an example of the data of the assistance image AIMG to be outputted to the display 31. In the example shown in FIG. 2, the data of the assistance image AIMG in a vicinity of a T-junction TJ is outputted to the display 31. This assistance image AIMG contains an image of a traffic mirror TM in front of the vehicle 2. The traffic mirror TM provided on a sidewalk adjoining the T-junction TJ. The traffic mirror TM has a convex mirror portion MR. In the example shown in FIG. 2, the mirror portions MR1 and MR2 respectively project objects on the roads leading to the T-junction TJ.

In order to secure a driving safety of the vehicle 2, it is desirable to recognize an object displayed on the mirror portion MR with a high resolution. In particular, when the remote operation is performed, it is desirable to recognize the object on the mirror portion MR with a high resolution even if the distance from the vehicle 2 to the traffic mirror TM is long. However, there is a limitation in a communication traffic in the communication data COM2. Therefore, it is expected that the resolution of the front image IMG received by the remote facility 3 is not so high.

Therefore, in the embodiment, it is determined whether the mirror portion MR image is included in the front image IMG received from the vehicle 2. And when it is determined that mirror portion MR image is included, a quality of an image of a preset region RE_{MR} is improved by applying a “super resolution technique” to the image of the preset region RE_{MR} including the mirror portion MR. The super-resolution technique is a technique for mapping inputted image data with low resolution to that with high resolution.

Examples of the super-resolution technique include a technique described in the following document. In this document, a SRCNN is disclosed in which a deep learning based on CNN (Convolutional Neural Network) is applied to the super-resolution (Super Resolution). A model for converting the inputted image data with low resolution into that with high resolution (hereinafter also referred to as a “super-resolution model MSR”) is obtained by machine-learning.

Chao Dong, Chen Change Loy, Kaiming He, and Xiaoou Tang, “Image Super-Resolution Using Deep Convolutional Networks”, arXiv:1501.00092v3[cs.CV], Jul. 31, 2015 (https://arxiv.org/pdf/1501.00092.pdf)

Processing to improve the resolution of image data by inputting entering the image data in the super-resolution model MSR is referred to as “super-resolution processing”. The image of the preset region RE_{MR} improved by the super-resolution processing is referred to as a “super-resolution image SIMG”. In the embodiment, when the super-resolution image SIMG is generated, display control is executed to be outputted to the display 31 not only data of this super-resolution image SIMG but also data of the front image IMG simultaneously. In this display control, processing is executed to divide a portion of the display 31 for outputting the data of the super-resolution image SIMG while outputting the data of the front image IMG to a remaining region. Note that the method to divide the region of the display 31 is not particularly limited, and a known method is applied thereto.

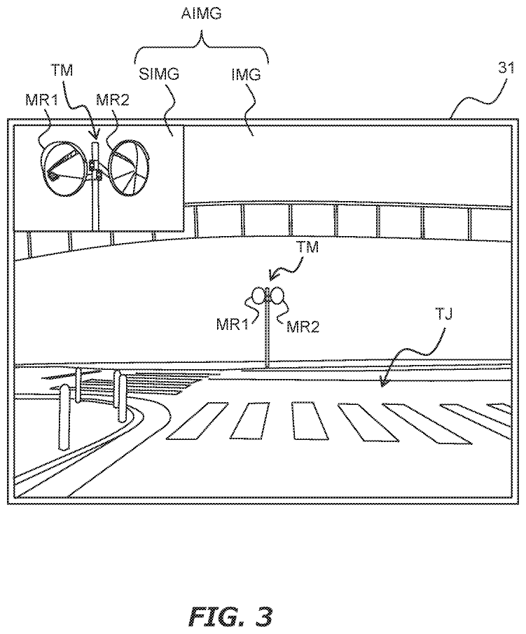

FIG. 3 is a schematic diagram illustrating an example of the data of the assistance image AIMG to be outputted to the display 31 when the super-resolution image SIMG is generated. In the example shown in FIG. 3. the super-resolution image SIMG is output in an upper left region of the display 31 while the front image IMG is outputted in the remaining region of the display 31. The size of the super-resolution image SIMG is resized according to the size of the region for outputting this data. There is no limitation on the method of resizing, and a known method is applied thereto.

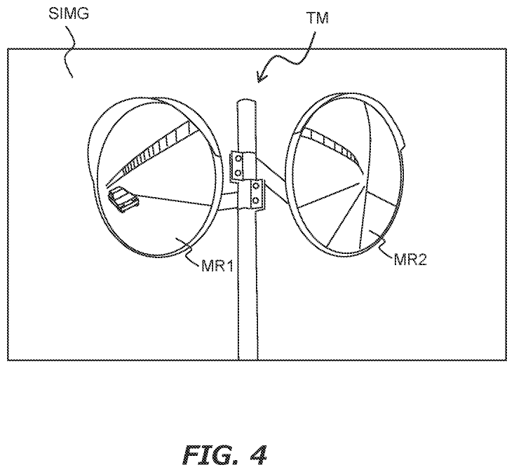

FIG. 4 is an enlarged view of the super-resolution image SIMG shown in FIG. 3. By outputting such the super-resolution image SIMG to the display 31, the operator can easily recognize the object displayed on the mirror portion MR even if the vehicle 2 is distant from the traffic mirror TM. Therefore, the driving safety of the vehicle 2 during the remote assistance by the operator can be ensured.

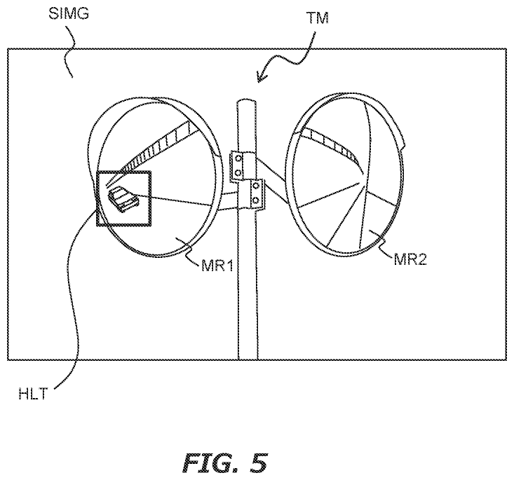

FIG. 5 is a diagram illustrating another example of the super-resolution image SIMG. In the example shown in FIG. 5, a highlighted frame HLT is added to the super-resolution image SIMG that surrounds a moving object (specifically, a vehicle) that displayed on the mirror portion MR1. The method to detect the moving object will be described later. When the highlighted frame HLT is added to the super-resolution image SIMG, it is possible to call the operator's attention to the moving object. Therefore, it is expected that the driving safety of the vehicle 2 during remote assistance will be improved.

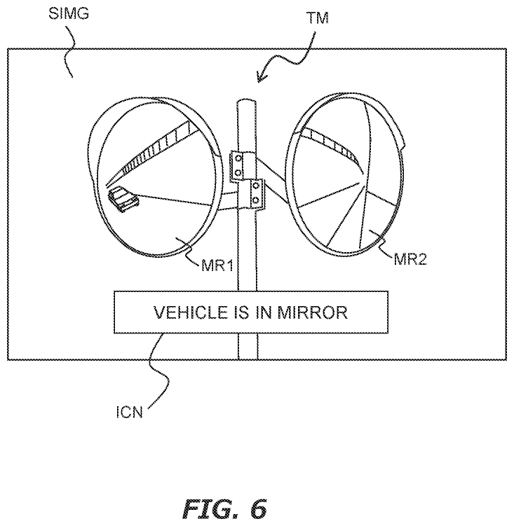

FIG. 6 is a diagram illustrating still another example of the super-resolution image SIMG. In the example shown in FIG. 6, a reminder icon ICN corresponding to a type of the moving object displayed on the mirror portion MR1 is added to the super-resolution image SIMG. The method to detect the moving object and the method to select the reminder icon ICN corresponding to the type of the moving object will be described later. When the reminder icon ICN is added to the super-resolution image SIMG, the same effect as when the highlighted frame HLT is added is expected.

Hereinafter, the remote assistance system according to the embodiment will be described in detail.

### 2. Remote Assistance System

### 2-1. Configuration Example of Vehicle

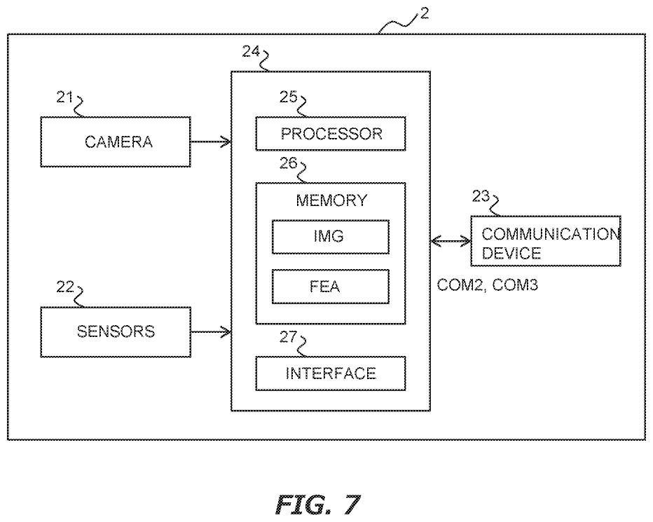

FIG. 7 is a block diagram illustrating a configuration example of the vehicle 2 shown in FIG. 1. As shown in FIG. 7, the vehicle 2 comprises the camera 21, sensors 22, a communication device 23, and a data processing device 24. The camera 21, the sensors 22 and the communication device 23 are connected to the data processing device 24 by, for example, a network mounted on the vehicle (for example, a CAN (Controller Area Network)). The description of the camera 21 is as described above in the explanation in FIG. 1.

The sensor 22 includes a state sensor that detects a status of the vehicle 2. Examples of the state sensor include a velocity sensor, an acceleration sensor, a yaw rate sensor, and a steering angle sensor. The sensors 22 also includes a position sensor that detects a position and an orientation of the vehicle 2. Examples of the position sensor include a GNSS (Global Navigation Satellite System) sensor. The sensors 20 may further include other recognition sensors other than the camera 21. The recognition sensors include a sensor recognizing (detecting) an environment surrounding the vehicle 2 using radio waves or light. Examples of the recognition sensors include a millimeter wave radar and a LIDAR (Laser Imaging Detection and Ranging).

The communication device 23 performs a wireless communication with a base station (not shown) of the network 4. Examples of the communication standard of this wireless communication include a mobile communication standard such as 4G, LTE, and 5G. Examples of a connection point of the communication device 23 include the remote facility 3. In the communication with the remote facility 3, the communication device 23 transmits to the remote facility 3 the communication data COM2 received from the data processing device 24.

The data processing device 24 is a computer to process various data acquired by the vehicle 2. The data processing device 24 includes at least one processor 25, at least one memory 26, and an interface 27. The processor 25 includes a CPU (Central Processing Unit). The memory 26 is a volatile memory such as a DDR memory, which develops program used by the processor 25 and temporarily stores various data. Various data acquired by the vehicle 2 is stored in the memory 26. This various data includes the data of the front image IMG described above. The various data also contains data of the feature quantity FEA of an object included in the front image IMG. The interface 27 is an interface with external devices such as the camera 21 and the sensors 22.

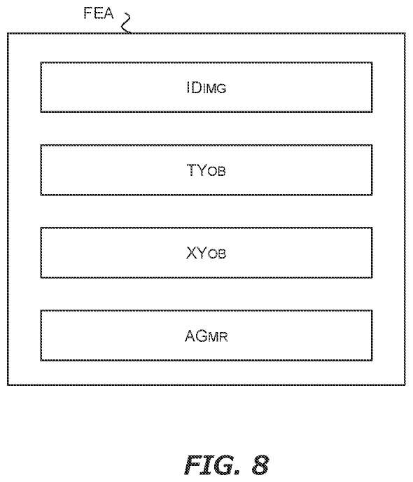

FIG. 8 is a diagram illustrating a configuration example of the data of the feature quantity FEA. In the example shown in FIG. 8, the data of the feature quantity FEA includes data of a distinguished ID_{IMG} of the front image IMG (e.g., a hashed value of a time stamp). The data of the feature quantity FEA also includes data of a type TY_{OB} of the object included in the front image IMG and data of a coordinate XY_{OB} of the object in the front image IMG.

The type TY_{OB} is preset according to the type of the object that is supposed to be on the road. Examples of the object include a still object and a moving object. Examples of the still object include a transportation facility such as a traffic light, a guard rail, a traffic mirror, and a roadway mark. Examples of the moving object include a walker, a bicycle, a motorcycle, and a vehicle other than the vehicle 2. The data of the type TY_{OB} and the coordinate XY_{OB} is associated with the data of the identifying ID_{IMG}.

The processing to recognize the moving object, the processing to identify the type of the recognized moving object, and the processing to identify the coordinate in the front image IMG of the recognized moving object are included in the data processing executed by the processor 25. Note that the method of the data processing is not particularly limited, and a known method is applied.

The data of the feature quantity FEA further includes the data of slope angle AG_{MR}. The data of the slope angle AG_{MR} is also associated with the data of the distinguished ID_{IMG}. The data of the slope angle AG_{MR} is generated when the front image IMG includes an image of the mirror portion MR and the added to the data of the feature quantity FEA. That is, if the image of the mirror portion MR is not included in the front image IMG, the data of the slope angle AG_{MR} is not generated or added to the data of the feature quantity FEA.

The slope angle AG_{MR} is an inclination of the mirror portion MR relative to a base surface. The base surface is defined as a surface perpendicular to a travel direction of the vehicle 2 (an optical axis direction of the camera 21) within a plane perpendicular to the ground (i.e., a vertical plane). Since the mirror portion MR has a convex shape, for example, a plane passing through a plurality of points constituting the outer periphery of the mirror portion MR is virtually set. By using this virtual plane, the inclination of the mirror portion MR can be estimated.

The slope angle AG_{MR} can be estimated, for example, by assuming that the shape of the mirror portion MR is known and solving a PnP problem for the coordinate of a plurality of points (i.e., the coordinates on the world coordinate system) that consists of the outer periphery of the mirror portion MR. Examples of the solution method of the PnP problem include a technique shown in the following document.

Gao, X.-S., X.-R. Hou, J. Tang, and H. F. Cheng. “Complete Solution Classification for the Perspective-Three-Point Problem.” IEEE Transactions on Pattern Analysis and Machine Intelligence, Volume 25, Issue 8, pp. 930-943, August 2003

In another case, the slope angle AG_{MR} is estimated by applying CNN-based deep learning to the mirror portion MR. Examples in which the CNN-based deep learning is used include a technique shown in the following document.

Yu Xiang, Tanner Schmidt, Venkatraman Narayanan, Dieter Fox. “PoseCNN: A Convolutional Neural Network for 6D Object Pose Estimation in Cluttered Scenes”, CVPR 2018

The processor 25 executes to generate the data of the feature quantity FEA. The processor 25 also encodes the data of the front image IMG and the feature quantity FEA and outputs the encoded data to the communication device 23 via the interface 27. During the encoding process, the data of the front image IMG and the feature quantity FEA data may be compressed. The data of the encoded front image IMG and feature quantity FEA is included in the communication data COM2.

Note that the encoding process of the data of the front image IMG and the feature quantity FEA may not be executed by using the processor 25 and the memory 26. For example, the various processes described above may be executed by software processing in a GPU (Graphics Processing Unit) or a DSP (Digital Signal Processor), or by hardware processing in an ASIC or a FPGA.

### 2-2. Configuration Example of Remote Facility

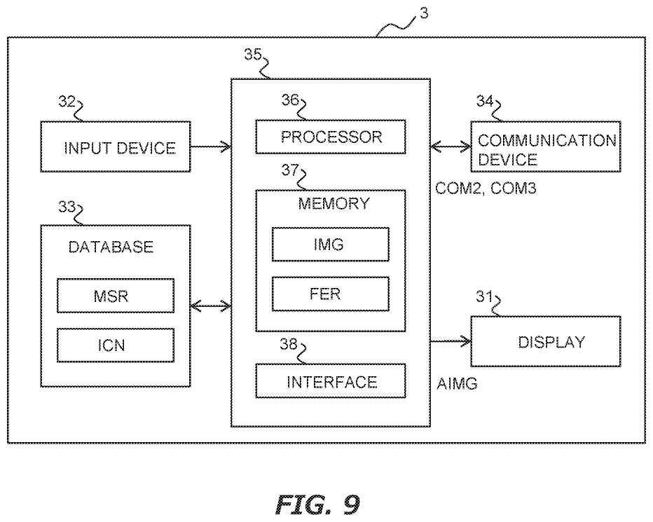

FIG. 9 is a block diagram illustrating a configuration example of the remote facility 3 shown in FIG. 1. As shown in FIG. 9, the remote facility 3 includes the display 31, an input device 32, a database 33, a communication device 34, and a data processing device 35. The data processing device 35 and the input device 32, the database 33 and the communication device 34 are connected by a dedicated network. Note that the explanation of the display 31 is as already described in the explanation of FIG. 1.

The input device 32 is a device operated by the operator of the remote facility 3. The input device 32 includes, for example, an input unit for a receiving an input from the operator, and a control circuit for generating and outputting the data of the assistance instruction based on the input. Examples of the input unit include a touch panel, a mouse, a keyboard, buttons, and a switch. Examples of the input from the operator is an operation to move a cursor displayed on the display 31 and an operation to select a button displayed on the display 31.

When the operator performs the remote operation of the vehicle 2, the input device 32 may be provided with an input device for driving. Examples of the input device for driving include a steering wheel, a shift lever, an accelerator pedal, and a brake pedal.

The database 33 is a nonvolatile storage medium such as a flash memory or a hard disk drive (Hard Disk Drive). The database 33 stores various program and various data required for the remote assistance (or the remote operation) of the vehicle 2. Examples of this various data include a super-resolution model MSR. In this embodiment, several super-resolution model MSRs are prepared depending on the number of sizes that are expected to be in the size of the preset region RE_{MR}. The reason why several super-resolution model MSRs are prepared is that, in the deep learning for the super-resolution processing (e.g., SRCNN), a fixed-size image data needs to be inputted.

The various data stored in the database 33 may include data of the reminder icon ICN. Note that the explanation of the reminder icon ICN is as already described in the explanation of FIG. 6. The data of the reminder icon ICN is prepared for each type of the moving object that is expected to be displayed on the mirror portion MR. Examples of this moving object include a walker, a bicycle, a motorcycle, and a vehicle other than the vehicle 2.

The communication device 34 performs a wireless communication with a base station of the network 4. Examples of the communication standard of this wireless communication include a mobile communication standard such as 4G, LTE, and 5G. Examples of a connection point of the communication device 34 include the vehicle 2. In the communication with the vehicle 2, the communication device 34 transmits to the vehicle 2 the communication data COM3 received from the data processing device 35.

The data processing device 35 is a computer to process various data. The data processing device 35 includes at least one processor 36, at least one memory 37, and an interface 38. The processor 36 includes a CPU. The memory 37 develops program used by the processor 36 and temporarily stores various data. The signals inputted from the input device 32 and various data acquired by the remote facility 3 are stored in the memory 37. This various data includes the front image IMG and the feature quantity FEA contained in the communication data COM2. The interface 38 is an interface with external devices such as the input device 32, the databases 33, and the like.

The processor 36 executes processing to decode the data of the front image IMG and the feature quantity FEA. The processor 36 also executes “image generation processing” to generate data of the assistance image AIMG based on the decoded data. If the data of the front image IMG and the feature quantity FEA are compressed, these data are decompressed during the decoding process. The processor 36 also executes “display control processing” in which the generated assistance image AIMG is outputted to the display 31 via the interface 38.

Note that the decoding of the data of the front image IMG and the feature quantity FEA, the image generation processing, and the display control processing may not be executed by using the processor 36, the memory 37, and the database 33. For example, the various processes described above may be executed by software processing in a GPU or a DSP, or by hardware processing in a ASIC or a FPGA.

### 2-3. Function Configuration Example of the Data Processing Device of the Vehicle

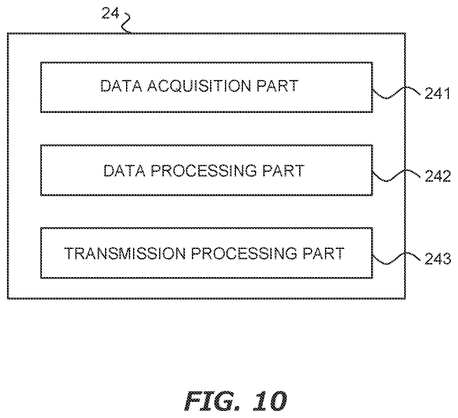

FIG. 10 is a block diagram showing a function configuration example of the data processing device 24 shown in FIG. 7. As shown in FIG. 10, the data processing device 24 includes a data acquisition part 241, a data processing part 242, and a transmission processing part 243.

The data acquisition part 241 acquires data of surrounding environment of the vehicle 2, data of driving state of the vehicle 2 and data of location of the vehicle 2. Examples of the surrounding environment data include data of the front image IMG described above. Examples of the driving state data include driving speed data, acceleration data, yaw rate data, and steering angle data of the vehicle 2. These driving state data are measured by the sensors 22. The location data is measured by the GNSS sensor.

The data processing part 242 processes various data acquired by the data acquisition part 241. The processing of the various data includes processing to generate the data of the feature quantity FEA. In the generation processing of the data of the feature quantity FEA, it is determined whether the front image IMG includes the image of the mirror portion MR. If it is determined that the front image IMG includes the image of the mirror portion MR, generation processing is executed to generate the data of the slope angle AG_{MR}. The processing of the various data includes processing to encode the data of the front image IMG and the data of the feature quantity FEA.

The transmission processing part 243 transmits the data of the front image IMG that is encoded by the data processing part 242 (i.e., the communication data COM2) to the remote facility 3 (i.e., the communication device 34) via the communication device 23.

### 2-4. Function Configuration Example of the Data Processing Device of the Remote Facility

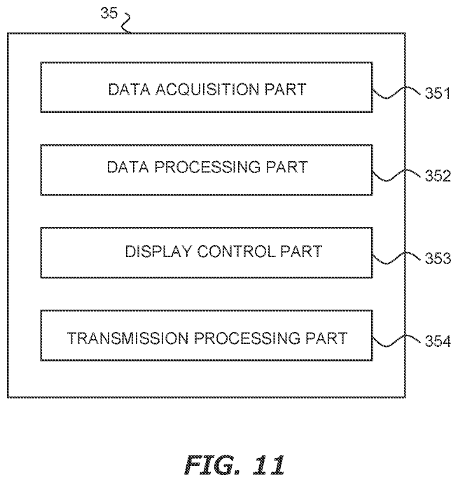

FIG. 11 is a block diagram illustrating a function configuration example of the data processing device 35 shown in FIG. 9. As shown in FIG. 11, the data processing device 35 includes a data acquisition part 351, a data processing part 352, a display control part 353, and a transmission processing part 354.

The data acquisition part 351 obtains the input signal from the input device 32 and the communication data COM2 from the vehicle 2.

The data processing part 352 processes various data acquired by the data acquisition part 351. The processing of the various data includes processing to encode the data of the assistance instruction from the operator. The data of the encoded assistance instruction is included in the communication data COM3. The processing of the various data includes processing to decode the data of the front image IMG and the feature quantity FEA, and the image generation processing.

In the image generation processing, the data processing part 352 determines whether the data of the decoded feature quantity FEA includes the data of the type TY_{OB} indicating the type of the traffic mirror TM. When it is determined that the data of the type TY_{OB} indicating the type of traffic mirror TM is not included, the data processing part 352 transmits the data of the front image IMG as the data of the assistance image AIMG to the display control part 353.

When it is determined that data of the type TY_{OB} indicating the type of traffic mirror TM is included, the data processing part 352 executes preprocessing for the super-resolution processing. In this preprocessing, first, a coordinate of a recognition region RE_{TM} of the traffic mirror TM is specified based on the data of the coordinate XY_{OB} of the traffic mirror TM. As described above, the data of the coordinate XY_{OB} is the data of the coordinate of the object included in the front image IMG. In the preprocessing, an image of a preset region RE_{MR} is extracted from the front image IMG based on the coordinate of the recognition region RE_{TM}.

The data processing part 352 then inputs the image of this preset region RE_{MR} into the super-resolution model MSR. Thus, a super-resolution image SMIG is obtained. The data processing part 352 transmits the data of the obtained super-resolution image SMIG along with the data of the front image IMG to the display control part 353.

The data processing part 352 may detect a moving object in the mirror portion MR in the image generation processing. The detection processing of the moving object is executed when the decoded data of the feature quantity FEA includes the data of the type TY_{OB} indicating the type of the traffic mirror TM and the data of the slope angle AG_{MR}. IN the detection processing of the moving object, for example, a distortion correction of the image of the preset region RE_{MR} is executed based on the slope angle AG_{MR} and a curvature radius (known) of the mirror portion MR. An image of the preset region RE_{MR} after the distortion correction (hereinafter also referred to as a “corrected image”) includes an orthoscopic image of the mirror portion MR.

If the corrected image of the preset region RE_{MR} is generated, the data processing part 352 inputs this corrected image into the super-resolution model MSR. The corrected image of the preset region RE_{MR} of winch resolution is improved by being inputted into the super-resolution model MSR is also referred to as a “super-resolution corrected image”. The data processing part 352 applies the deep learning using YOLO (You Only Look Once) network to this super-resolution corrected image. Alternatively, the data processing part 352 applies the deep learning using SSD (Single Shot multibox Detector) network to this super-resolution corrected image. Then, the moving object included in the orthoscopic image is detected.

When the data processing part 352 detects the moving object included in the orthoscopic image, it may superimpose the super-resolution image SIMG with a highlighted frame HLT surrounding the moving object in the super-resolution image SIMG. Alternatively, the data of the reminder icon ICN corresponding to the moving object included in the orthoscopic image may be selected by referring to the database 33, and the reminder icon ICN may be superimposed on the super-resolution image SIMG. The highlighted frame HLT and the reminder icon ICN are additional information of the super-resolution image SIMG. The data processing part 352 transmits the data of the super-resolution image SMIG to which the additional information was added along with the data of the front image IMG to the display control part 353.

The display control part 353 executes the display control processing. The display control processing is executed based on the assistance image AIMG generated by the data processing part 352. The display control part 353 also controls a display content of the display 31 based on the input signal acquired by the data acquisition part 351. In the control of the display content based on the input signal, for example, the display content is enlarged or reduced based on the input signal, or a switching of the display content (transition) is performed. In another example, the cursor on the display 31 is moved based on the input signal, or the button output on the display 31 is selected.

The transmission processing pan 354 transmits the data of the assistance instruction (i.e., the communication data COM3) encoded by the data processing part 352 to the vehicle 2 (i.e., the communication device 23) via the communication device 34.

### 2-5. First Processing Example by the Data Processing Device

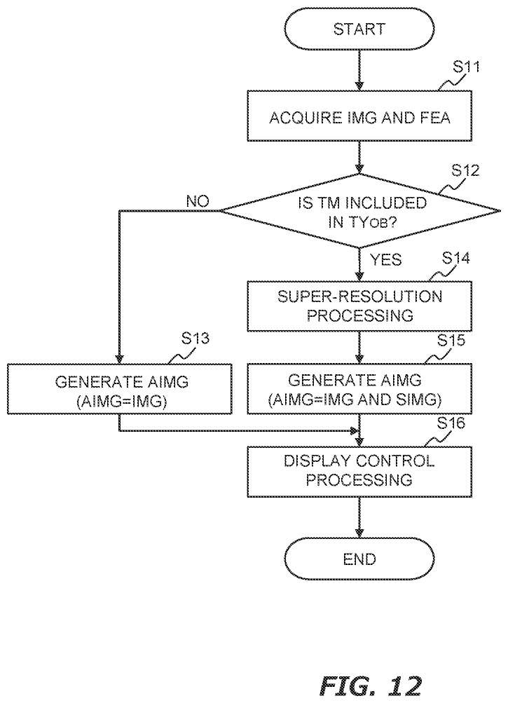

FIG. 12 is a flowchart illustrating an example of processing (the image generation processing and the display control processing) executed by the data processing device 35 (the processor 36) shown in FIG. 9. The routine shown in FIG. 12 is repeatedly executed at a predetermined control cycle when, for example, the processor 36 receives the assist requiring signal to the remote facility 3. Note that the assist requiring signal is included in the communication data COM2.

In the routine shown in FIG. 12, first, the data of the front image IMG and the data of the feature quantity FEA is acquired (step S11). The data of the image IMG and the data of the feature quantity FEA are that after the decoding.

After the processing of the step S11, it is determined whether the data of the traffic mirror TM is included in the data of the type TY_{OB} (step S12). As discussed in FIG. 8, the feature quantity FEA includes the type TY_{OB}. In the processing of the step S12, it is determined whether the data of the type TY_{OB} includes the data indicating the type of the traffic mirror TM.

If the judgement result of the step S12 is negative, the assistance image AIMG is generated (step S13). In this case, the data of the assistance image AIMG is the data of the front image IMG. On the other hand, if the judgement result of the step S12 is positive, the super-resolution processing is executed (in step S14).

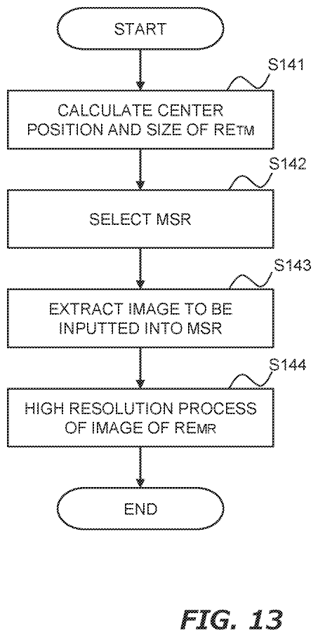

Here, the super-resolution processing will be described with reference to FIG. 13. FIG. 13 is a flowchart illustrating a flow of the super-resolution processing shown in the step S14 of FIG. 12.

In the routine shown in FIG. 13, a center position, and a size of the recognition region RE_{TM} are calculated (step S141). As stated in the explanation of FIG. 8, the data of the feature quantity FEA includes the data of the type TY_{OB} of the object included in the front image IMG and the data of the coordinate XY_{OB} of the said object in the said front image IMG. That is, when the data of the type TY_{OB} indicating the type of the traffic mirror TM is included in the data of the feature quantity FEA, the data of the feature quantity FEA also includes the data of the coordinate XY_{OB} of the traffic mirror TM. The center position and size of the recognition region RE_{TM} are calculated based on the data of the coordinate XY_{OB} of the traffic mirror TM.

After the processing of the step S141, a selection of the super-resolution model MSR is executed (step S12). In the processing of the step S142, a reference to the database 33 is performed by using the size of the recognition region RE_{TM} calculated in the processing of the step S141. Then, a super-resolution model MSR having a size close to this size and also having a longer input than the said size in longitudinal and transverse directions is selected.

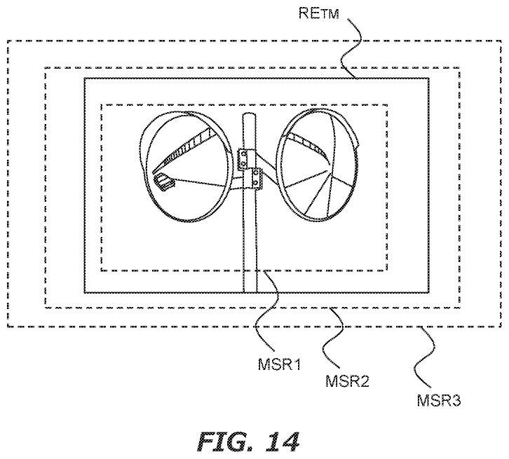

FIG. 14 is a diagram illustrating an outline of the processing of the step S142. As mentioned above, several super-resolution model MSRs are prepared depending on the number of sizes that are expected to be in the size of the preset region RE_{MR}. Super-resolution models MSR1, MSR2 and MSR3 shown in FIG. 14 are examples of the super-resolution model MSRs. In the processing of the step S142, the super-resolution model MSR2 satisfying the size condition mentioned above is selected.

After the processing of the step S142, an image to be inputted to the super-resolution model MSR is extracted (step S143). In the processing of the step S143, an image of a size matching the input of the super-resolution model MSR selected in the processing of the step S142 (i.e., the super-resolution model MSR2) is extracted from the data of the front image IMG. The extraction of the image is executed by cutting out an area centered on the coordinate of the center position calculated in the step S141 by a size corresponding to the input of the size of the super-resolution model MSR. The extracted image corresponds to the image of the preset region RE_{MR}.

After the processing of the step S143, high resolution process of the image of the preset region RE_{MR} is executed (step S144). In the processing of the step S144, the data of the image (i.e., the image of the preset region RE_{MR}) extracted by the processing of the step S143 is inputted into the super-resolution model MSR selected in the processing of the step S142 (i.e., the super-resolution model MSR2). As a result, the super-resolution image SIMG is obtained.

Return to FIG. 12 and continue to explain the processing example. After the processing of the step S14, the data of the assistance image AIMG is generated (step S15). The data of the assistance image AIMG in this case is the data of the front image IMG and the data of the super-resolution image SIMG.

After the processing of the step S13 or S15, the display control processing is executed (step S16). The display control processing is executed based on the data of the assistance image AIMG generated in the step S13 or S15. If the data of the assistance image AIMG generated in the step S13 is used, the data of the front image IMG is output to the display 31 as it is. If the data of the assistance image AIMG generated in the step S15 is used, the super-resolution image SIMG data is output to a part of the display 31 while the data of the front image IMG is output to the remaining area.

### 2-6. Second Processing Example by the Data Processing Device

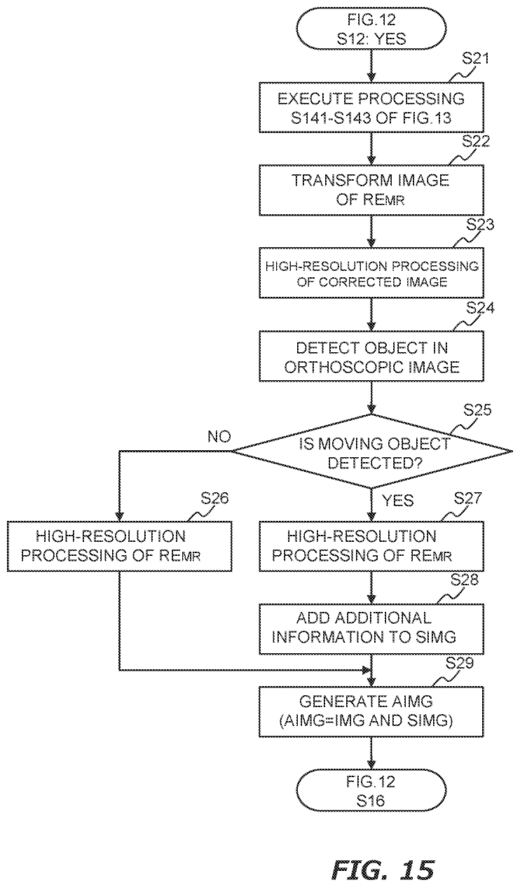

FIG. 15 is a flowchart illustrating another example executed by the data processing device 35 (processor 36) shown in FIG. 9. The routine shown in FIG. 15 is executed when the judgement result of the step S12 of the routine shown in FIG. 12 is positive.

In the routine shown in FIG. 15, first, the same processing as the processing of the step S141 to S143 shown in FIG. 13 is executed (step S21). That is, the preprocessing for the super-resolution is executed in the step S21.

After the processing of the step S21, a transformation of the image of the preset region RE_{MR} is executed (step S22). In the processing of the step S22, using the slope angle AG_{MR} and the curvature radius of the mirror portion MR. (known), the distortion of the image extracted by the processing of the step S21 (more precisely, the image of the preset region RE_{MR} extracted by the same processing as the processing of the step S143 shown in FIG. 13) is corrected. The image of the preset region RE_{MR} after the distortion correction (i.e., the corrected image of the preset region RE_{MR}) includes the orthoscopic image of the mirror portion MR.

After the processing of the step S22, the high-resolution processing of the corrected image of the preset region RE_{MR} is executed (step S23). In the processing of the step S23, the data of the preset region RE_{MR} obtained by the processing of the step S22 is inputted into the super-resolution model MSR selected by the processing of the step S21 (more precisely, the super-resolution model MSR selected by the same processing as the processing of the step S142 shown in FIG. 13). As a result, a super-resolution corrected image is obtained.

After the processing of the step S23, the moving object in the orthoscopic image is detected (step S24). In the processing of the step S24, for example, the deep learning using the YOLO network, or the SSD network is applied to the super-resolution corrected image obtained by the processing of the step S23.

After the processing of the step S24, it is determined whether the moving object is detected in the orthoscopic image (step S25). The processing of the step S25 is executed, for example, based on time-series data of the super-resolution corrected image (the orthoscopic image). If there is an object whose ratio in the entire area of the mirror portion MR changes in the time-series data, it is determined that the object is a moving object. The object of which an occupation ratio increases is the moving object approaching the vehicle 2. On the other hand, the object of which the occupation ratio decreases is the moving object away from vehicle 2.

If the judgement result in the step S25 is negative, the high-resolution processing of the image of the preset region RE_{MR} is executed (step S26). Even if the judgement result in the step S25 is positive, the high-resolution processing of the image of the preset region RE_{MR} is executed (step S27). The processing of steps S26 and S27 is the same as that of the step S144 shown in FIG. 13. When the processing of the step S27 is executed, the super-resolution image SIMG is obtained.

After the processing of the step S27, an additional information is added to the super-resolution image SIMG (step S28). The additional information is the highlighted frame HLT or the reminder icon ICN. In a case where the highlighted frame is added, the moving object detected in the step S24 is superimposed on the super-resolution image SIMG so as to surround it. In a case where the reminder icon ICN is added, the data of the reminder icon ICN corresponding to the moving object detected in the processing of the step S24 is selected by referring to the database 33. The selected reminder icon ICN is then superimposed on an area of the super-resolution image SIMG in the vicinity of the moving object.

After the processing of the step S26 or S28, the data of the assistance image AIMG is generated (step S29). The processing of the steps S26 and S27 is the same as the processing of the step S15 shown in FIG. 12.

### 3. Effect

According to the embodiment described above, when the front image IMG includes the mirror portion MR image, the super-resolution image SIMG is generated from the image of the preset region RE_{MR} including the mirror portion MR and then outputted to the display 31. Therefore, even if the distance from vehicle 2 to traffic mirror TM is long, the operator can easily recognize the object displayed on the mirror portion MR. Therefore, the driving safety of vehicle 2 during the remote assistance by the operator can be ensured.

Further, according to the embodiment, the corrected image of the preset region RE_{MR} is generated by executing the distortion correction of the image of the preset region RE_{MR}. Further, based on the super-resolution corrected image generated from the corrected image, the object detection in the orthoscopic image is executed. And if the orthoscopic image includes a moving object, an additional information on the moving object is added to the super-resolution image SIMG. Therefore, the operator can easily recognize the moving object in the mirror portion MR.

What is claimed is:

1. A remote assistance system comprising a vehicle and a remote facility to assist an operation of the vehicle, the remote facility comprising:
a memory in which data of a front image representing an image in front of the vehicle and data of a feature quantity of an object included in the front image are stored; and
a processor configured execute image generation processing to generate assistance image data to be output to a display of the remote facility based on the front image data and the feature quantity data, and display control processing to output assistance image data to the display.
wherein, in the image generation processing, the processor is configured to:
based on the feature quantity data, determine whether the front image includes an image of a mirror portion of a traffic mirror;
If it is determined that the front image includes the image of the mirror portion, extract an image of a preset region including the mirror portion from the front image; and
execute super-resolution pro processing on the image of the preset region to generate a super-resolution image,
wherein, in the display control processing, the processor is configured to:
if the front image does not include the image of the mirror portion, output the front image data to the display as the assistance image data,
if the front image includes the image of the mirror portion, output the super-resolution image data and the front image data to the display as the assistance image data.

2. The remote assistance system according to claim 1,
wherein, in the display control processing, the processor is configured to:
if the front image includes the image of the mirror portion, output the super-resolution image data to a region of the display while outputting the front image data a remaining region of the display.

3. The remote assistance system according to claim 1,
wherein the feature quantity includes a slope angle of the mirror portion to a base surface,
wherein, in the image generation processing, the processor is configured to;
if it is determined that the front image includes the image of the mirror portion, before executing the super-resolution processing on the image of the preset region, execute a distortion correction of the image of the preset region based on the slope angle and a curvature radius of the mirror portion to generate a corrected image of the preset region including orthoscopic image of the mirror portion;
execute the super-resolution processing to the corrected image to generate a super-resolution corrected image;
detect a moving object in the orthoscopic image based on the super-resolution corrected image; and
if no moving object is detected in the orthoscopic image, execute the super-resolution processing on the image of the preset region to generate the super-resolution image data,
if a moving object is detected in the orthoscopic image, executed the super-resolution processing on the image of the preset region image to generate the super-resolution image data and add a highlighted frame surrounding the detected moving object to the generated super-resolution image.

4. The system according to claim 1,
wherein the remote facility further comprises a database in which reminder icon data set according to a type of a moving object is stored,
wherein the feature quantity includes a slope angle of the mirror portion to a base surface,
wherein, in the image generation processing, the processor is configured to:
if it is determined that the front image includes the image of the mirror portion, before executing the super-resolution processing on the image of the preset region, execute a distortion correction of the image of the preset region based on the slope angle and a curvature radius of the mirror portion to generate a corrected image of the preset region including orthoscopic image of the mirror portion;
execute the super-resolution processing to the corrected image to generate a super-resolution corrected image;
detect a moving object in the orthoscopic image based on the super-resolution corrected image; and
if no moving object is detected in the orthoscopic image, execute the super-resolution processing on the image of the preset region to generate the super-resolution image data,
if a moving object is detected in the orthoscopic image, select reminder icon data corresponding to the detected moving object by referencing the database with the detected moving object, execute the super-resolution processing on the image of the preset region to generate the super-resolution image data, and add the selected reminder icon to the generated super-resolution image.

5. A remote assistance method to assist an operation of a vehicle by a remote facility, the remote facility comprising:
a memory in which data of a front image representing an image in front of the vehicle and data of a feature quantity of an object included in the front image are stored; and
a processor configured execute image generation processing to generate assistance image data to be output to a display of the remote facility based on the front image data and the feature quantity data, and display control processing to output assistance image data to the display,
wherein the image generation processing includes:
processing to determine whether the front image includes an image of a mirror portion of a traffic mirror based on the feature quantity data;
processing to extract an image of a preset region including the mirror portion from the front image if it is determined that the front image includes the image of the mirror portion; and
processing to execute super-resolution processing on the image of the preset region to generate a super-resolution image,
wherein, the display control processing includes:
processing to output the front image data to the display as the assistance image data if the image of the mirror portion is not included in the front image, and
processing to output the super-resolution image data and the front image data to the display as the assistance image data if the image of the mirror portion is included in the front image.
